(19) United States
(12) Patent Application Publication
(10) Pub. No.: US 2006/0285448 A1
(43) Pub. Date: Dec. 21, 2006

(54) PHYSICAL ADDRESS DETECTOR, OPTICAL DISC APPARATUS AND METHOD OF DETECTING PHYSICAL ADDRESS

(75) Inventor: Satoru Kojima, Kawaguchi-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/422,977

(22) Filed: Jun. 8, 2006

(30) Foreign Application Priority Data
Jun. 17, 2005 (JP) 2005-177327

(51) Int. Cl. G11B 7/085

(52) U.S. Cl. 369/30.13

(57) ABSTRACT

A physical address detector capable of detecting a physical address correctly, reliably, and easily even when there are two types of synchronization signal patterns. The physical address detector includes an extraction section for extracting a first and a second segments each including first cycles each having a predetermined cycle and second cycles each having a predetermined number of the first cycles from a wobble waveform on an optical disc, a synchronization-signal detecting section for individually detecting a synchronization signal string disposed at the beginning of the first data segment and a synchronization signal string disposed at the position having a delay of a half of the first cycle from the beginning of the second data segment to generate a synchronization signal, a counter section for identifying a position of a physical address based on the synchronization signal, and an address extraction section for extracting the physical address data.

### BACKGROUND OF THE INVENTION

1. Field of the Invention

The present invention relates to a physical address detector, an optical disc apparatus and a method of detecting a physical address. More particularly, the present invention relates to a physical address detector which detects a physical address of an optical disc using a synchronization signal, an optical disc apparatus including the physical address detector, and a method of detecting a physical address.

2. Description of the Related Art

Various types of optical disc have become widespread today for recording media on which digital information of various kinds is recorded. Among these optical discs, DVDs have a higher recording density than CDs, and thus DVDs are becoming more widespread for recording moving pictures such as movies, etc., and for large-capacity recording media used for information processing apparatuses of various kinds.

At the same time, it is expected that contents to be recorded on optical discs will be shifted to high-quality moving pictures which are compatible with high-definition television. Accordingly, the demand for optical discs which achieve a higher storage capacity at a low cost has been increased more than ever.

In order to meet such a demand, next-generation DVD standards, typified by HD DVD, have been developed to achieve a higher storage capacity.

In DVDs, a physical address (information indicating a recording position of recording information on an optical disc) is recorded on an optical disc along with the recording information. The physical address data is recorded on an optical disc, for example by pitting an optical disc with sine-wave undulation called wobbles and performing phase modulation on this sine wave. Information is read from and written on a predetermined position on an optical disc by referencing the physical address read from the optical disc.

Reading of a physical address is performed by detecting a synchronization signal (SYNC signal) recorded on an optical disc on an approximately regular cycle, and generating predetermined timing from this synchronization signal.

Accordingly, in order to read a physical address correctly, it is assumed that a synchronization signal (SYNC signal) can be detected correctly. Thus, a technique for correctly detecting a synchronization signal (SYNC signal) without malfunctioning by noise, etc., becomes important.

For example, Japanese Unexamined Patent Application Publication No. 2003-123257 has disclosed a technique in which a SYNC detection window is provided for preventing false detection of a synchronization signal (SYNC signal) caused by noise, etc., in order to read a physical address correctly. Specifically, the patent document has disclosed a configuration in which one-bit binarized wobble signal (cycle 32T) is sampled by a recording frequency 1T, a counter (counter for counting up 1T) is cleared by the first rising edge of a SYNC pattern (range of cycle 32T), the SYNC detection window is opened in the range of ±y (y is an integer) with 128T after as center, and the signal detected in this SYNC detection window is used as a SYNC signal.

### SUMMARY OF THE INVENTION

Although the technique disclosed in the above patent document has a certain effect of eliminating malfunctions by noise, the technique is likely to be affected by disturbance such as noise, etc., because the technique is using one bit wobble signal. Also, if the first rising edge (a range of cycle 32T) of the SYNC pattern fails to be correctly detected, the counter is not cleared, and the SYNC detection window fails to be opened at the correct position. Accordingly, the possibility of the frequent occurrence of erroneous SYNC detection cannot be eliminated.

On the other hand, next-generation DVDs, typified by HD DVD, have remarkably increased recording density compared with a known DVD. It is therefore demanded for next-generation DVDs to have a technique of detecting a SYNC signal with higher reliability than before in order to obtain a physical address correctly.

Also, in a next-generation DVD standard called HD DVD-R (recordable (write once)), two kinds of different SYNC (synchronization signal) patterns are used. Two kinds of SYNC pattern called a primary segment type and a secondary segment type are provided on adjacent tracks on an optical disc, and thus the interference of the wobble signals across tracks (a phenomenon in which a wobble signal of an adjacent track leaks in a detected track to cancel the wobble signal of the detected track) is eliminated.

There has not been a SYNC pattern standard such as primary/secondary segment types before. It goes without saying that SYNC signals are also demanded to be detected with high reliability for these two kinds of different SYNC pattern described above. Also, a method of detecting the signal is demanded to be as simple as possible.

The present invention has been made in view of the circumstances described above. Accordingly, it is an object of the present invention to provide a physical address detector, an optical disc apparatus and a method of detecting a physical address which are capable of detecting a synchronization signal and a physical address correctly, easily, with a high reliability without being affected by disturbance such as noise, etc., even when there are two different kinds of synchronization signal pattern, such as primary/secondary segment types.

In order to solve the above-described problem, according to an embodiment of the present invention, there is provided an physical address detector including: an extraction section for extracting a first and a second data segments each including first cycles each having a predetermined cycle and second cycles each having a predetermined number of the first cycles from a wobble waveform recorded on an optical disc; a synchronization-signal detecting section for individually detecting a synchronization signal string disposed at the beginning of the first data segment and a synchronization signal string disposed at the position having a delay of a half of the first cycle from the beginning of the second data segment, and generating a synchronization signal; a counter section for counting up using one cycle of the wobble waveform as a basic unit on the basis of the synchronization signal in order to identify a position of a physical address included in the first and the second data segments; and an address extraction section for extracting the physical address data from the first and the second data segments on the basis of the position of the physical address data identified by the counter section, wherein the counter section includes a half-cycle counter using a half cycle of the first cycle as a repetition cycle, and a type-determination counter for inputting an output of the half-cycle counter, generating the first cycle, and determining either the first segment type or the second segment type is input.

Also, in order to solve the above-described problem, according to another embodiment of the present invention, there is provided an optical disc apparatus including: a drive section for rotationally driving an optical disc; a pickup for reading data from or writing data onto the optical disc; and a physical address detector for extracting a physical address recorded as a wobble waveform on the optical disc from an output of the pickup, wherein the physical address detector includes an extraction section for extracting a first and a second data segments each including first cycles each having a predetermined cycle and second cycles each having a predetermined number of the first cycles from a wobble waveform recorded on an optical disc, a synchronization-signal detecting section for individually detecting a synchronization signal string disposed at the beginning of the first data segment and a synchronization signal string disposed at the position having a delay of a half of the first cycle from the beginning of the second data segment, and generating a synchronization signal, a counter section for counting up using one cycle of the wobble waveform as a basic unit on the basis of the synchronization signal in order to identify a position of a physical address included in the first and the second data segments, and an address extraction section for extracting the physical address data from the first and the second data segment on the basis of the position of the physical address data identified by the counter section, wherein the counter section includes a half-cycle counter using a half cycle of the first cycle as a repetition cycle, and a type-determination counter for inputting an output of the half-cycle counter, generating the first cycle, and determining either the first segment type or the second segment type is input.

Also, in order to solve the above-described problem, according to another embodiment of the present invention, there is provided a method of detecting a physical address, including the steps of: extracting a first and a second data segments each including first cycles each having a predetermined cycle and second cycles each having a predetermined number of the first cycles from a wobble waveform recorded on an optical disc; synchronization-signal detecting for individually detecting a synchronization signal string disposed at the beginning of the first data segment and a synchronization signal string disposed at the position having a delay of a half of the first cycle from the beginning of the second data segment, and generating a synchronization signal; counting by a counter section for counting up using one cycle of the wobble waveform as a basic unit on the basis of the synchronization signal in order to identify a position of a physical address data included in the first and the second data segments; and address extracting for extracting the physical address data from the first and the second data segments on the basis of the position of the physical address data identified by the counting step, wherein the counting step includes half-cycle counting using a half cycle of the first cycle as a repetition cycle, and type-determination counting for inputting a signal for each of the half cycle obtained by the half-cycle counting step, generating the first cycle, and determining either the first segment type or the second segment type is input.

By the physical address detector, the optical disc apparatus and the method of detecting a physical address according to the present invention, it is possible to detect a synchronization signal and a physical address correctly, easily, with a high reliability without being affected by disturbance such as noise, etc., even when there are two kinds of different synchronization signal patterns, such as primary/secondary segment types.

### BRIEF DESCRIPTION OF THE DRAWINGS

FIG. 1 is a diagram illustrating an example of the configuration of an optical disc apparatus according to an embodiment of the present invention;

FIGS. 2A and 2B are diagrams illustrating the concept of a wobble signal of an optical disc;

FIGS. 3A to 3F are first diagrams illustrating the data format of a data segment recorded on an optical disc as a wobble signal;

FIGS. 4A to 4D are second diagrams illustrating the data format of a data segment recorded on an optical disc as a wobble signal;

FIG. 5 is a diagram illustrating an example of the configuration of a physical address detector according to an embodiment of the present invention;

FIG. 6 is a diagram illustrating an example of the configuration of a counter section in the physical address detector according to the embodiment of the present invention;

FIGS. 7A to 7G are first timing charts illustrating the operation of a physical address detector according to an embodiment of the present invention;

FIGS. 8A to 8I are second timing charts illustrating the operation of a physical address detector according to an embodiment of the present invention;

FIGS. 9A to 9G are third timing charts illustrating the operation of a physical address detector according to an embodiment of the present invention;

FIGS. 10A to 10H are fourth timing charts illustrating the operation of a physical address detector according to an embodiment of the present invention; and

FIGS. 11A to 11H are fifth timing charts illustrating the operation of a physical address detector according to an embodiment of the present invention.

### DESCRIPTION OF THE PREFERRED EMBODIMENTS

A description will be given of an embodiment of a physical address detector, an optical disc apparatus and a method of detecting a physical address according to the present invention with reference to the drawings.

1. Optical Disc Apparatus

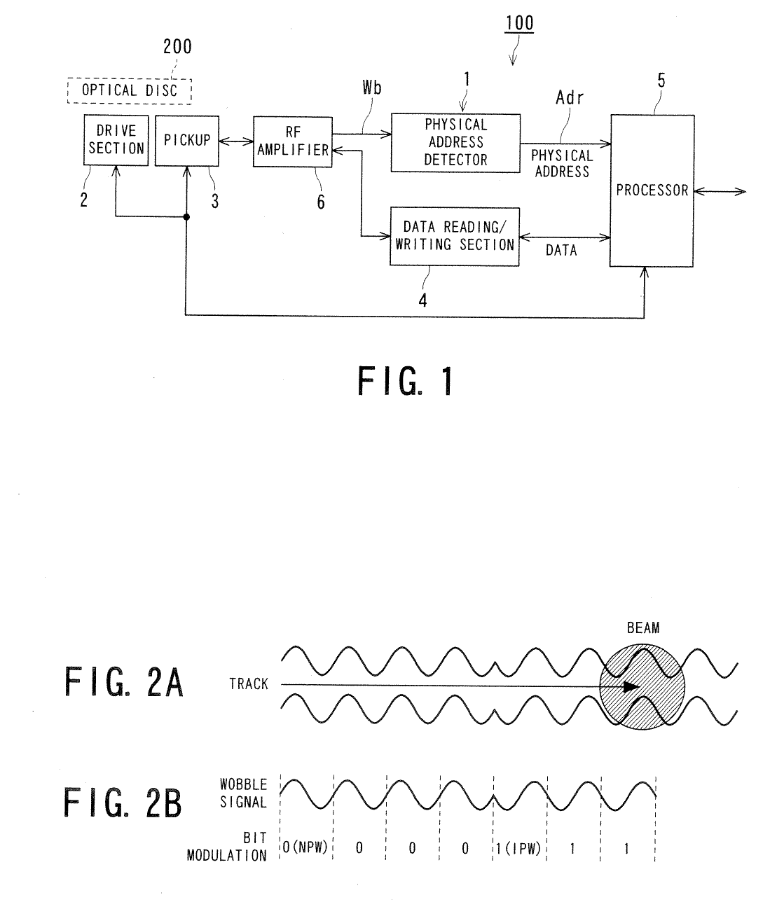

FIG. 1 is a diagram illustrating an example of the configuration of an optical disc apparatus according to an embodiment of the present invention.

An optical disc apparatus 100 includes a drive section 2 for rotationally driving an optical disc 200, a pickup 3 for reading the recorded information from and writing information onto the optical disc 200, an RF amplifier 6 for generating an RF signal which reads a wobble signal Wb and user data recorded on the optical disc 200, a physical address detector 1 for detecting physical address information, data reading/writing section 4 which reads the data recorded on the optical disc 200, performs predetermined data conversion, and performs predetermined data conversion for writing data onto the optical disc 200, and a processor 5 for performing the total control of the optical disc apparatus 100 and various data conversion.

The drive section 2 performs rotational control of the optical disc 200 on the basis of the control signal from the processor 5.

The pickup 3 records information onto and reproduces information from the optical disc 200. A laser beam emitted from the pickup 3 to the optical disc 200 is subjected to modulation by a pit recorded on the track of the optical disc 200, and the reflected laser beam is input into the data reading/writing section 4. In reverse, the intensity of a laser beam of the pickup 3 is modulated by the write data output from the data reading/writing section 4, and a pit is formed on a track of the optical disc 200 by the modulated laser beam to write information.

Also, the pickup 3 extracts the wobble (undulation) recorded along the track of the optical disc 200 in a sine-wave state as the intensity of a reflected laser beam, and outputs it as a wobble signal Wb to the physical address detector 1 through the RF amplifier 6.

FIGS. 2A and 2B are diagrams illustrating the concept of the wobble signal Wb. FIG. 2A schematically shows the shape of the track on the optical disc 200. The track of the optical disc 200 is formed in the shape of an undulated sine wave in the direction of travel. Each one of this undulation is called a wobble. The laser beam emitted from the pickup 3 moves on the track having this undulation, and thus the reflected light is subjected to amplitude modulation in accordance with the shape of the undulation.

FIG. 2B shows a signal which has been subjected to the amplitude modulation by the undulation (wobble), that is to say, the wobble signal Wb. The wobble has two kinds of sine waveform, NPW having a positive phase and IPW having an inverted phase. Each of the wobbles can represent binary (“0” and “1”) data (one bit) by two kinds of wobble, a positive phase and a negative phase. In the example of FIG. 2A and 2B, NPW and IPW correspond to “0” and “1”, respectively. The example shows a state in which there are four consecutive bits of “0”, and then there are three consecutive bits of “1”.

On the optical disc 200, a physical address is assigned to each predetermined area unit, and this physical address is recorded on the optical disc 200 by the wobble signal Wb.

The wobble signal Wb output from the RF amplifier 6 is input into the physical address detector 1. As described below, the physical address detector 1 detects a synchronization signal from the wobble signal Wb, and extracts a physical address on the basis of this synchronization signal.

When data is written onto the optical disc 200, the data is written in accordance with the physical address extracted from the wobble signal Wb.

Also, the processor 5 can process data corresponding to a physical address of the optical disc 200, thus making it possible to perform random access on the optical disc 200.

In addition, the processor 5 performs the drive control on the drive section 2 and the position control, the focus control, etc., of the pickup 3.

2. Data Format of Wobble Signal Wb

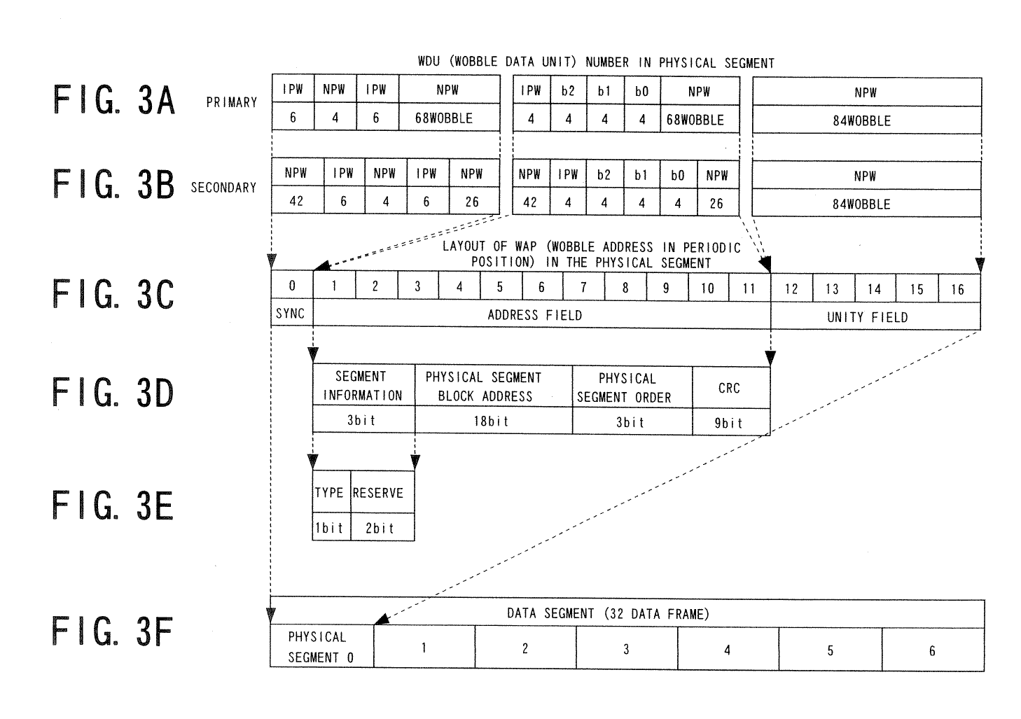

FIGS. 3A to 3F are diagrams illustrating the data format of a physical address represented by a wobble signal Wb.

The physical address is included in a packet of data string called a segment or WAP, and one physical address corresponds to one segment.

FIGS. 3(a) to 3(c) are diagrams illustrating the data format called a segment or WAP (in the following, simply called a segment).

As shown in FIG. 3C, one segment includes 17 data units shown from 0 to 16. This data unit is called a WDU. That is to say, a segment includes 17 WDUs, namely the 0th to the 16th WDUs.

The 0th WDU (the beginning WDU of a segment) is a WDU having a synchronization signal string, and is indicated by “SYNC” in FIG. 3C.

One physical address is included in 11 WDUs, namely the 1st to the 11th WDUs, and indicated by “Address Field”. The 11 WDUs represents 33-bit information.

As shown in FIG. 3D, the details of the 33 bits include 3-bit “Segment Information”, 18-bit “Physical Segment Block Address”, 3-bit “Physical Segment Order”, and 9-bit “CRC”.

Among these, a physical address on the optical disc 200 is actually represented by the 18-bit “Physical Segment Block Address” and the 3-bit “Physical Segment Order”.

The 9-bit “CRC” is an error-correcting code. Also, as shown in FIG. 3E, the 3-bit “Segment Information” includes 2-bit reserve and one bit indicating the type of segment.

The 12th to the 16th WDUs are area called “Unity Field”, and is an area not to be modulated.

There are two types of segment, which are individually called a primary segment type and a secondary segment type.

FIG. 3A shows the data format of the segment of the primary segment type (a first data segment). FIG. 3B shows the data format of the segment of the secondary segment type (a second data segment).

The two types of segment individually include 17 WDUs in common. However, the internal structure of the segments are different in the beginning WDU including a synchronization signal string and the 1st to the 11th WDUs of “Address Field”.

Both types of segment include individual WDUs each including 84 wobbles. As described in FIGS. 2A and 2B, one wobble corresponds to a sine wave of one cycle, and is either NPW, which is a positive sine wave, or IPW, which is a negative sine wave.

As shown in FIG. 3A, the beginning WDU (the 0th WDU) of the segment of the primary segment type includes, from the beginning, a 6-wobble IPW, a 4-wobble NPW, and a 6-wobble IPW. The sum of these, 16 wobbles, constitute a synchronization signal string of the segment. IPW and NPW correspond to “1” and “0”, respectively (see FIGS. 2A and 2B), and thus this synchronization signal string is equivalent to a bit string of “1111110000111111”. The beginning WDU includes 68-wobble NPW “000 . . . ” after the 16-wobble synchronization signal string, and thus includes 84 wobbles in total.

Next to the 0th WDU, the 1st to the 11th WDUs of “Address Field” are arranged. Each WDU includes a 4-wobble IPW at the beginning, and then subsequently, four wobbles are individually assigned to “b2”, “b1”, and “b0”.

Each one bit of the 3 bits, which are produced when the 33-bit physical address, etc., shown in FIG. 3D is divided by 11 (from the 1st to the 11th), is individually assigned to “b2”, “b1”, and “b0”. Depending on the contents of the physical address, etc., IPW (corresponding to “1”) or NPW (corresponding to “0”) is allocated for each four wobbles.

Next to “b2”, “b1”, and “b0”, a 68-wobble NPW “000 . . . ” is arranged, and thus the WDUs of “Address Field” include 84 wobbles in the same manner as the 0th WDU.

Although each of the 1st to the 11th WDUs has different contents of “b2”, “b1”, and “b0” depending on the contents of the physical address, etc., but has completely the same data arrangement.

In this regard, in order to distinguish the 4-wobble IPW “1111” disposed at the beginning of each WDU of “Address Field” from the synchronization signal string disposed at the beginning of a segment, the former is called a unit synchronization signal string.

Next to 11-WDU “Address Field”, there are five (from the 12th to the 16th) WDUs of “Unity Field”. All of these five WDUs include an 84-wobble NPW. After all, “Unity Field” includes 420 (=5×84) NPWs “000 . . . ”.

On the other hand, in the segment of the secondary segment type, as shown in FIG. 3B, the position of the synchronization signal string in the 0th WDU is different from that of the primary segment type. The beginning of the 0th WDU includes 42-wobble NPW “000 . . . ”, and then includes a synchronization signal string “1111110000111111”. That is to say, assuming that the length of a WDU (84 wobbles) is one cycle, the synchronization signal string starts from the beginning with just a half-cycle delay.

For the 11-WDU “Address Field”, the 42-wobble NPW “000 . . . ” is disposed at the beginning, and then the unit synchronization signal string “1111” is disposed. In this case, in the same manner as the 0th WDU, assuming that the length of a WDU (84 wobbles) is one cycle, the unit synchronization signal string “1111” also starts from the beginning of each WDU with a half-cycle delay.

In this manner, the positions of the synchronization signal string and the unit synchronization signal string in the primary segment type and those of the secondary segment type are disposed with a half-cycle delay of WDU. It becomes therefore necessary to have a method of detecting a physical address in accordance with the two types appropriately when synchronization detection is performed from the synchronization signal string and the unit synchronization signal string in order to extract a physical address.

In this regard, the primary segment type and the secondary segment type are provided in order to eliminate the interference of the wobble signals across tracks (a phenomenon in which a wobble signal of an adjacent track leaks in a detected track to cancel the wobble signal of the detected track) by having two different kinds of wobble signal Wb pattern on adjacent tracks on an optical disc.

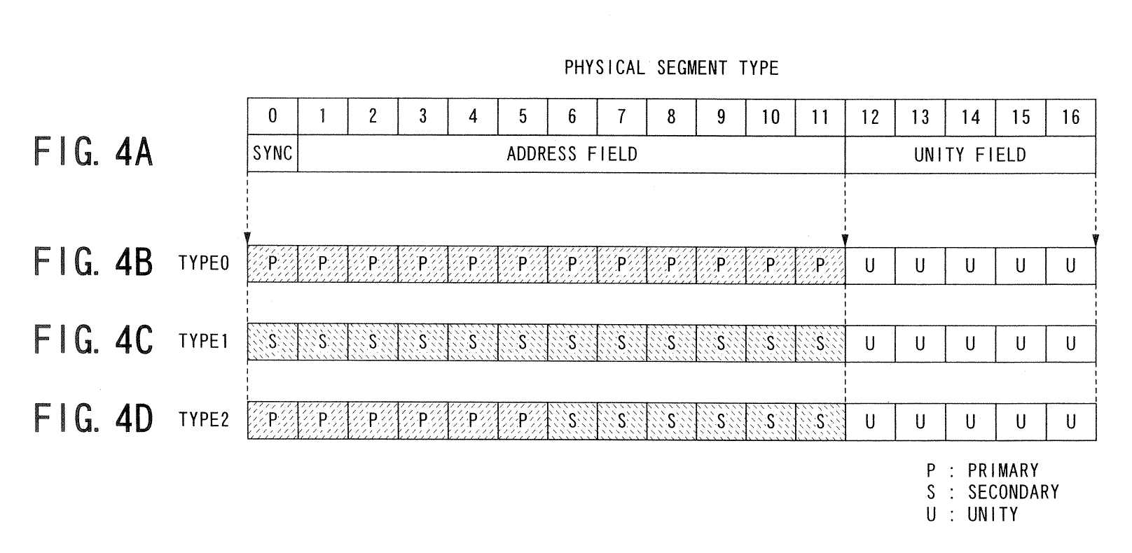

FIGS. 4A to 4D show the primary segment type (Type 0), the secondary segment type (Type 1), and a segment of the combination of both (Type 2). “P” or “S” added to each WDU of “SYNC” and “Address Field” indicates that they are the WDUs corresponding to the primary segment type and the secondary segment type, respectively.

The segment of the Type 2 includes “P”-type WDUs from the 0th to the 5th and then includes “S”-type WDUs from the 6th to the 11th. In this manner, the segment of the Type 2 changes to the mode in which the unit synchronization signal string starts from the beginning of each WDU with a half-cycle delay from the 6th and after.

3. Configuration of Physical Address Detector

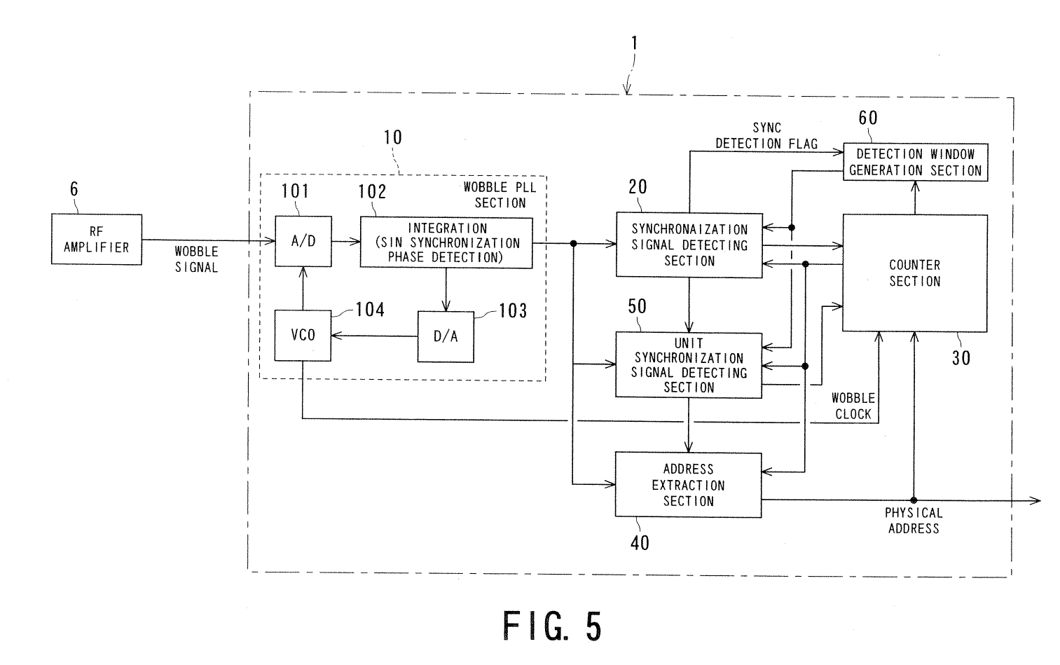

FIG. 5 is a diagram illustrating an example of the configuration of a physical address detector 1 according to an embodiment of the present invention.

The physical address detector 1 receives the input of the wobble signal Wb from the RF amplifier 6, and generates a wobble clock. In addition, the physical address detector 1 includes a wobble PLL section 10 (extraction section) for generating a “+” value and a “−” value from the wobble signal Wb having been subjected to phase modulation, a synchronization signal detecting section 20 for detecting the synchronization signal string in the beginning WDU of the data segment and generating a synchronization signal, a counter section 30 for counting up on the basis of the synchronization signal, and an address extraction section 40 for extracting from the data segment a physical address data disposed at the position having a predetermined amount of displacement from the synchronization signal by referencing a count value of the counter section 30.

Also, the physical address detector 1 may include a unit-synchronization signal detecting section 50 for detecting the unit-synchronization signal string disposed at the beginning of each WDU of the “Address Field” of the data segment.

Furthermore, the physical address detector 1 may include a detection-window generation section 60 for generating a detection window at the position where the synchronization signal is to be detected on the basis of the count value of the counter section.

The wobble PLL section 10 receives the input of the wobble signal Wb, and outputs the “+” value for IPW, and the “−” value for NPW. The “+” value corresponds to “1” in FIGS. 2A and 2B, and the “−” value corresponds to “0” in FIGS. 2A and 2B.

The conversion from IPW/NPW into the “+” value/the “−” value may be performed by various methods. In the present embodiment, as shown in FIG. 5, a PLL circuit including an A/D converter 101, an integrator 102, a D/A converter 103, and a VCO 104 is used.

The PLL circuit performs phase synchronization of the wobble signal Wb with a SIN wave to be a reference, and performs integration processing, and thus outputs the “+” value and the “−” value in accordance with the positive phase and the negative phase of the wobble signal Wb.

Also, the wobble PLL section 10 generates the wobble clock Wclk synchronized with each wobble (each cycle of the sine wave) of the input wobble signal Wb. The wobble clock Wclk is used as a clock signal of the counter section.

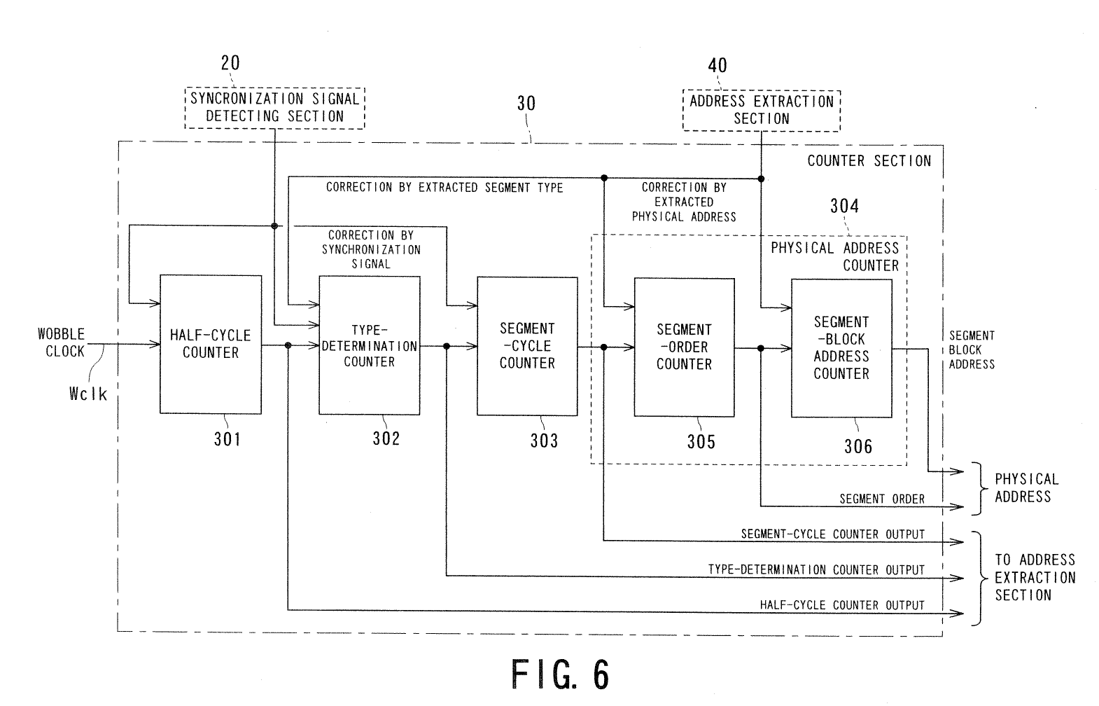

FIG. 6 is a diagram illustrating an example of the detailed configuration of the counter section 30.

The counter section 30 includes five types of counter, that is to say, a half-cycle counter 301, a type-determination counter 302, a segment-cycle counter 303, a segment-order counter 305, and a segment-block address counter 306.

The half-cycle counter 301 counts up the wobble clock Wclk using a hale cycle of the WDU as a cycle period. As shown in FIGS. 3A and 3B, all the WDUs include 84 wobbles, and thus the 84 wobbles constitute one cycle (a first cycle) The half-cycle counter 301 repeatedly counts a half of the cycle, that is to say, 42 wobbles from the 0th to the 41th.

Next, the type-determination counter 302 determines a carry of the half-cycle counter 301. The output of the type-determination counter 302 is one bit, and the type-determination counter 302 outputs “1” and “0” alternatively when there is a carry of the half-cycle counter 301.

As a result, the output of the type-determination counter 302 classifies a WDU into “1” and “0” for each half cycle. Also, the cycle of the output of the type-determination counter 302 (an interval between “1” and “1”) corresponds to one cycle of the WDU.

The next-stage segment-cycle counter 303 is a counter counted up for each WDU, and has a cycle of the data segment (a second cycle) as a cycle period. As shown in FIGS. 3A to 3C, both of the primary segment type and the secondary segment type includes 17 WDUs, and the segment-cycle counter 303 repeatedly counts 17 WDUs from the 0th to the 16th.

The half-cycle counter 301, the type-determination counter 302, and the segment-cycle counter 303 are counted up on the basis of the synchronization signal string in the beginning of the segment. Accordingly, it is basically possible to identify the position of each bit of the physical address included in the segment by the output of these three kinds of counters. However, the segment mixedly contains two kinds, the primary segment type and the secondary segment type. The positions of the synchronization signal string of the two kinds are different, and thus it becomes necessary to correct the counter in reality (the correction of the type-determination counter 302). A description will be given on this point later.

The next-stage physical address counter 304 includes a segment order counter 305 and a segment block address counter 306, and calculates a physical address. Primarily, a physical address is recorded in the segment as data, and thus the physical address counter 304 is not necessary in terms of address extraction.

The physical address counter 304 is provided in order to obtain a physical address independently from the physical address recorded in the segment and to increase the reliability of the physical address eventually.

In the optical disc 200 to which the present embodiment is applied, one physical address is assigned to one segment. Also, physical addresses increase for each segment along the track of the optical disc 200. Therefore, if the initial value of the physical address counter 304 is set (corrected) by the physical data recorded in the segment, a physical address can be obtained by the physical address counter 304 after that.

For example, the data of the area of a physical address may be corrupted by the influence of noise, etc. In this case, an error is detected by CRC, and the extracted physical address becomes impossible to be used. Even in this case, if the area of the synchronization signal string in the segment is normal, it is possible for the physical address counter 304 to output a correct physical address. Thus, it is possible to prevent the loss of a physical address on the whole.

4. Operation of Physical Address Detector

A description will be given of the operation of the physical address detector 1 having the above-described configuration, and in particular, the operation of the case where there are two kinds of segment, the primary segment type and the secondary segment type mixedly.

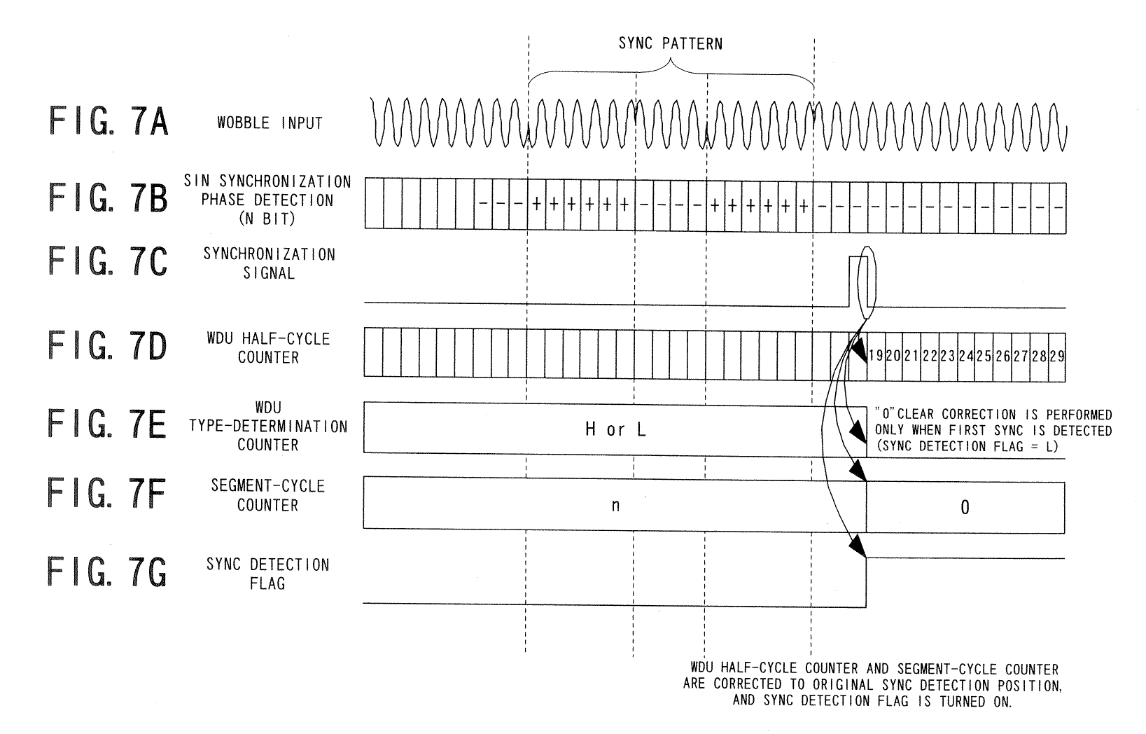

FIGS. 7A to 7G are charts illustrating a timing relationship in a situation in which synchronization detection is performed for the first time such as just after the power is turned on, or the like.

The waveform of FIG. 7A shows the wobble signal Wb to be input into the wobble PLL section 10. In the central part of the waveform, there is a SYNC pattern (synchronization signal string) included in the beginning WDU (the 0th WDU) of the segment.

The waveform of FIG. 7B is the output of the integrator 102 (integration SIN synchronization phase detection) of the wobble PLL section 10, and contains the synchronization sign string “++++++−−−−++++++” at the position corresponding to the SYNC pattern.

The synchronization signal of FIG. 7C is the output of the synchronization-signal detecting section 20. When the synchronization signal sting is detected, if it is determined that there is the synchronization signal sting, a pulse-shaped synchronization signal is generated immediately after the detection.

The method of detecting the synchronization signal string is not limited. However, the pattern of the synchronization signal string itself is fixed. It is possible to detect the synchronization signal on predetermined criteria by the comparison between the fixed synchronization signal string and the input signal string.

Also, the processing delay time from the detection of the synchronization signal out of the synchronization signal string to the generation of the pulse-shaped synchronization signal is specific to an apparatus. In the embodiment exemplified in FIGS. 7A to 7G, the pulse of the synchronization signal rises with a 19-wobble delay from the beginning of the synchronization signal string.

The half-cycle counter 301, the type-determination counter 302, and the segment-cycle counter 303 in the counter section 30 sets (corrects) the initial values at the falling of the pulse of the synchronization signal.

First, as shown by the waveform of FIG. 7D, the half-cycle counter 301 (WDU half-cycle counter) sets the count value to “19” by the falling of the synchronization signal pulse. This is equivalent to the setting of the count value of the half-cycle counter 301 to “0” at the beginning of the SYNC pattern (synchronization signal string).

FIG. 7E shows the output waveform of the type-determination counter 302 (WDU type-determination counter). The output of the type-determination counter 302 is either “0 (L)” or “1 (H)”. Thus, in the present embodiment, the state of the output of the type-determination counter 302 corresponds to the segment type. That is to say, for the primary segment type, the setting is performed such that the front part of the half-cycle area (area including the synchronization signal string) of the beginning WDU of the segment becomes “0 (L)”. For the secondary segment type, the setting is performed such that the latter part of the half-cycle area (area including the synchronization signal string in the same manner) of the beginning WDU of the segment becomes “1 (H)”.

In general, it is not determined whether the primary segment type or the secondary segment type is input unless the data (“Type bit” in FIG. 3E) recorded in the segment is referenced.

However, the type-determination counter 302 which changes the output for each half cycle is provided, and the state (“0 (L)” or “1 (H)”) of the output is made to correspond to two kinds of segment type. Thus, it becomes possible to determine whether the primary segment type or the secondary segment type has been input simply by referencing only one bit of the output of the type-determination counter 302 without referencing the recorded data in the segment all the way. Accordingly, the system configuration becomes simple.

However, when a segment is first input at the time of turning the power on, etc., it is unknown whether that segment is the primary segment type or the secondary segment type.

Thus, in this case, as shown in FIG. 7E, the input segment is temporarily determined to be the primary segment type, and is compulsorily set (corrected) to be “0 (L)”.

After that, “Type bit” of the data recorded in the segment is referenced, and the output of the type-determination counter 302 is determined (changed when “Type bit” is “1”, that is to say, the case of the secondary segment type).

Once determined, even if the type of the input segment is changed, it becomes possible to determine the type only by referencing the output of the type-determination counter 302 without referencing “Type bit”.

The waveform of FIG. 7F shows the output of the segment-cycle counter 303. The output is cleared to zero by the fall of the synchronization signal. The segment-cycle counter 303 counts 17 WDUs, from the 0th to the 16th, on the basis of the synchronization signal.

The waveform of FIG. 7G shows a SYNC detection flag. The SYNC detection flag is a signal indicating that the synchronization signal string has been detected in each segment.

FIGS. 8A to 8I are diagrams illustrating the operation after the synchronization signal string has been detected once.

When the synchronization signal string is detected once, it is possible to obtain the position where next synchronization signal is to be generated from the output of each counter on the basis of the synchronization signal. Thus, in the present embodiment, a detection-window generation section 60 (see FIG. 5) generates a SYNC detection window (detection window) having a predetermined width with the predicted position of the next synchronization signal as center. The waveform of FIG. 8G shows this SYNC detection window. In the example of FIG. 8G, the width of the window is three wobbles. However, the width is not limited to this value.

The SYNC detection window is input to the synchronization-signal detecting section 20, and only the synchronization signal that has passed the SYNC detection window is output as a true synchronization signal. Thus, it becomes possible to eliminate the synchronization signals (false synchronization signals) generated at the positions different from the original position by noise, etc. The synchronization signal that has passed the SYNC detection window is regarded as a true synchronization signal.

On the other hand, a relative relationship between the output value of the counter and the synchronization signal may fluctuate by the influence of noise, etc. Although the half-cycle counter 301 operates on the basis of the wobble clock Wclk, this wobble clock Wclk sometimes drops off by the influence of noise, etc. Also, the S/N ratio of the synchronization signal string sometimes deteriorates by noise, etc., and the detection position may fluctuate.

In the present embodiment, when the relative positional relationship between the output value of the counter and the synchronization signal is out of alignment, the half-cycle counter 301 is corrected on the basis of the position of the detected synchronization signal.

In the example shown in FIGS. 8A to 8I, the output of the half-cycle counter 301 counts one wobble ahead of the position of the SYNC pattern (synchronization signal string) (see FIG. 8D).

Thus, the synchronization signal is confirmed to be in the SYNC detection window (see FIG. 8H), and then the output of the half-cycle counter 301 is corrected to be delayed one wobble using the synchronization signal. In FIG. 8D, the counter has been corrected to be “19”, while the counter should have been “20” if not corrected.

In this manner, in the present embodiment, even if the relative positional relationship between the output value of the counter and the synchronization signal fluctuates by the influence of noise, etc., the half-cycle counter 301 is corrected on the basis of the synchronization signal. Thus, it becomes possible to always keep a constant relative positional relationship between the output value of the counter and the synchronization signal. As a result, it becomes possible to extract physical address data always at the right position from the segment data.

In this regard, the type-determination counter 302 is corrected by the synchronization signal only when the synchronization signal string is first detected (see FIGS. 7A to 7G). When the synchronization signal string is once detected, if the SYNC detection flag is on, the correction is not performed at the timing of the synchronization signal. The correction of the type-determination counter 302 when the SYNC detection flag is on is not performed on the basis of the position of the synchronization signal, but is performed on the basis of the data (“Type bit”).

FIGS. 8A to 8I show the operation to eliminate the influence of noise, etc., by compulsorily correcting the half-cycle counter 301 when a discrepancy between the synchronization signal and the half-cycle counter 301 arises by the detection of the synchronization signal string in the beginning of the segment.

On the other hand, as shown in FIGS. 3(a) and 3(b), each WDU in “Address Field” is provided with the 4-wobble unit-synchronization signal string “1111” similar to the synchronization signal string. The same operation as FIGS. 8A to 8I may be performed on each WDU in “Address Field” using this unit-synchronization signal string.

Specifically, the unit synchronization signal detecting section 50 shown in FIG. 5 detects the unit-synchronization signal string “1111” by the same method as the synchronization-signal detecting section 20 to generate a pulse-shaped unit-synchronization signal. Furthermore, the counter section 30 may generate the detection window of FIG. 8G for each WDU in “Address Field”.

The half-cycle counter 301 is corrected when a discrepancy between the unit-synchronization signal that has passed the detection window and the output of the half-cycle counter 301 arises.

In this manner, it becomes possible to correct malfunctions due to noise, etc., in a short cycle by correcting the half-cycle counter 301 using not only the synchronization signal generated at the beginning of the segment, but also the unit-synchronization signal of each WDU in “Address Field”. Thus, the reliability is improved.

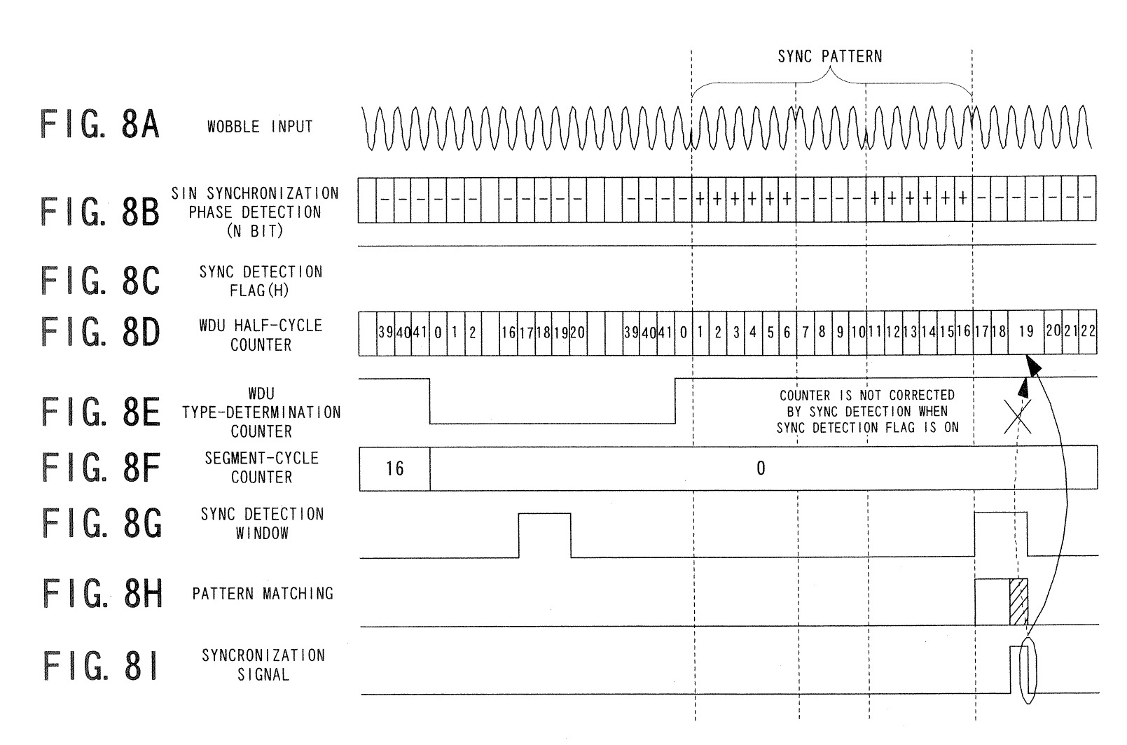

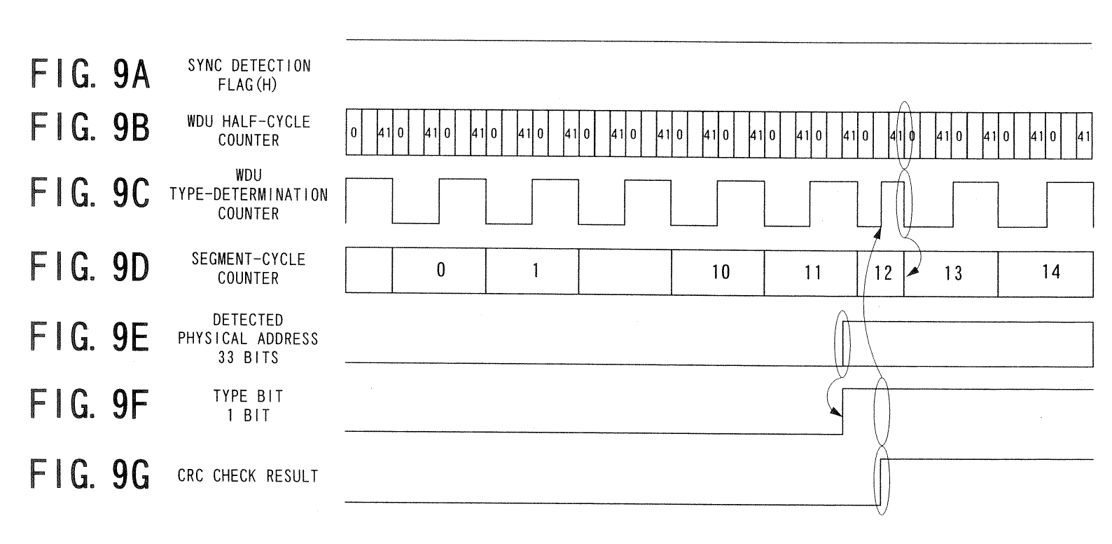

FIGS. 9A to 9G are charts illustrating the correction operation of the type-determination counter 302. In particular, a description will be given of the operation for determining the output of the type-determination counter 302 that has been temporarily determined after the synchronization signal string is detected.

When the synchronization signal string is detected, it is possible to extract a physical address, etc., from the segment. As shown in FIG. 3D, a physical address, etc., is constituted by the 33-bit data, and includes “Type bit” indicating the type of segment. For “Type bit”, “0 (L)” and “1 (H)” correspond to the primary segment type and the secondary segment type, respectively.

Thus, after the synchronization signal string is detected, and when a determination is made that there is no code error by the check using the extracted CRC code, “Type bit” is referenced and the output of the type-determination counter 302 is corrected in accordance with that type. In the example of FIGS. 9A to 9G, since the extracted “Type bit” is “1 (H)”, that is to say, the secondary segment type, the output of the type-determination counter 302 is changed from “0 (L)” (primary segment type) to “1 (H)” (the secondary segment type) at the time when the CRC check becomes effective.

The reason why the correction is performed at the time when the CRC check becomes effective is to confirm the reliability of the extracted “Type bit” data. In addition, in order to further increase the reliability, a determination on whether the correction by “Type bit” is allowed may be made by referencing the physical address data and, for example using the information of whether the segment order changes continuously by one, or the like.

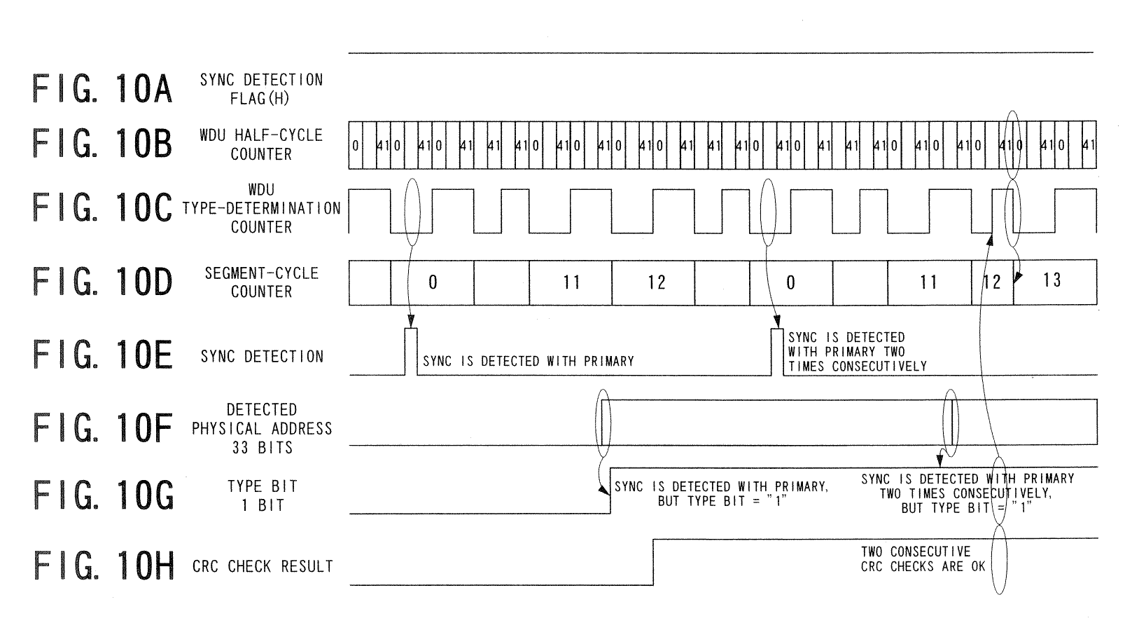

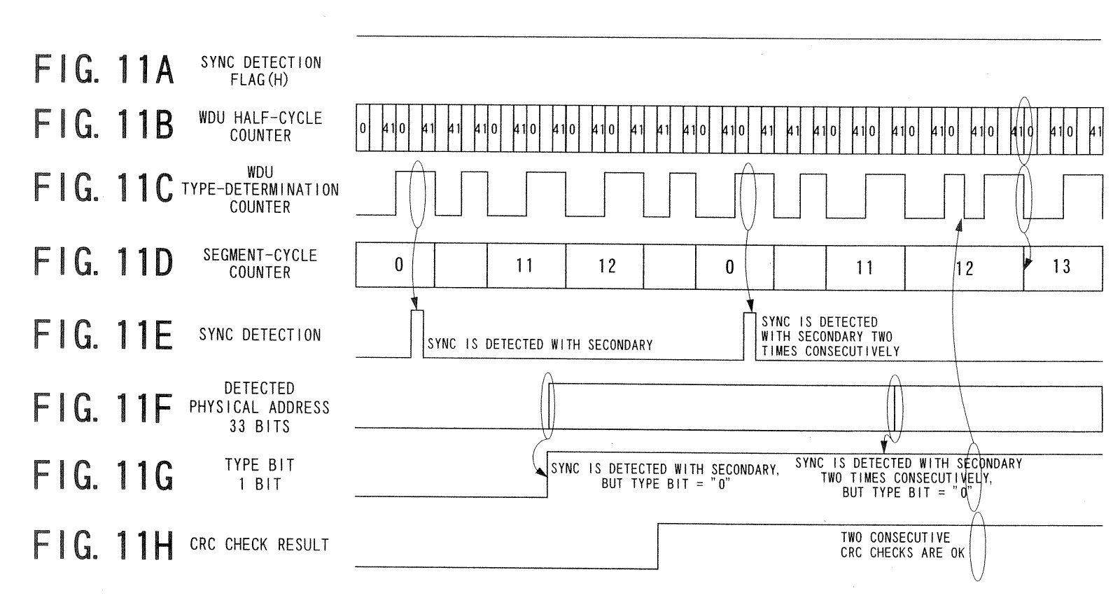

FIGS. 10 and 11 show the operation of correcting the type-determination counter 302 when the type indicated by the output of the type-determination counter 302 and the type indicated by “Type bit” are different in a state in which the SYNC detection flag is on (state in which the synchronization signal string has been detected once or more).

FIGS. 10A to 10H are the case where the output of the type-determination counter 302 is “0 (L)” immediately after the synchronization signal so that the type is determined to be the primary segment type, whereas “Type bit” indicates “1 (H)” (secondary segment type).

In order to ensure the reliability of the correction, for example, the output of the type-determination counter 302 is corrected from “0 (L)” to “1 (H)”, only when the type-determination counter 302 consecutively outputs “0 (L)” two times immediately after the synchronization signal, “Type bit” has “1 (H)” two times consecutively, and the CRC checks are normal at both times.

Contrary to FIGS. 10A to 10H, FIGS. 11A to 11H are the case where the output of the type-determination counter 302 is “1 (H)” immediately after the synchronization signal so that the type is determined to be the secondary segment type, whereas “Type bit” indicates “0 (L)” (the primary segment type).

In this case as well, for example, the output of the type-determination counter 302 is corrected from “1 (H)” to “0 (L)”, only when the type-determination counter 302 consecutively outputs “1 (H)” two times immediately after the synchronization signal, “Type bit” has “0 (L)” two times consecutively, and the CRC checks are normal at both times.

In this manner, in the present embodiment, even when there are two kinds of segment, the primary segment type and the secondary segment type, it is possible to determine two types only by referencing the output of the type-determination counter 302.

Also, after the output of the type-determination counter 302 is set once, it is not necessary to determine the segment type by referencing the extracted data every time, and it is sufficient to confirm that a malfunction due to noise, etc., has not occurred at appropriate intervals.

Also, assuming that a discrepancy occurs between the segment type indicated by the output of the type-determination counter 302 and the segment type indicated by the extracted data because of noise, etc., it is possible to correct the type-determination counter 302 by a simple method with high reliability.

Also, by separating the half-cycle counter 301 from the type-determination counter 302, the correction of the type-determination counter 302 needs only the correction of one bit, and thus simple correction becomes possible.

In this regard, each of the above-described embodiments of the present invention is not limited as it is. The present invention can be carried out in various ways by modifying components without departing from the spirit and the scope of the invention. Also, various inventions may be made by appropriately combining a plurality of the components disclosed in each of the above-described embodiments. For example, some components may be deleted from all the components shown in each embodiment. Furthermore, several components may be appropriately combined from all the components of different embodiments.

What is claimed is:

1. A physical address detector comprising:
an extraction section for extracting a first and a second data segments each including first cycles each having a predetermined cycle and second cycles each having a predetermined number of the first cycles from a wobble waveform recorded on an optical disc;
a synchronization-signal detecting section for individually detecting a synchronization signal string disposed at the beginning of the first data segment and a synchronization signal string disposed at the position having a delay of a half of the first cycle from the beginning of the second data segment, and generating a synchronization signal;
a counter section for counting up using one cycle of the wobble waveform as a basic unit on the basis of the synchronization signal in order to identify a position of a physical address included in the first and the second data segments; and
an address extraction section for extracting the physical address data from the first and the second data segments on the basis of the position of the physical address data identified by the counter section,
wherein the counter section includes
a half-cycle counter using a half cycle of the first cycle as a repetition cycle, and
a type-determination counter for inputting an output of the half-cycle counter, generating the first cycle, and determining either the first segment type or the second segment type is input.

2. The physical address detector according to claim 1, further comprising a detection-window generation section for generating a detection window having a predetermined detection width with a position at which the synchronization signal is to be detected as center on the basis of an output of the half-cycle counter,
wherein the synchronization-signal detecting section detects the synchronization signal when there is the synchronization signal in a range of the detection window.

3. The physical address detector according to claim 1,
wherein when the synchronization signal has already been detected, if a reference position indicated by the half-cycle counter does not match a reference position indicated by the synchronization signal, the synchronization-signal detecting section corrects an output of the half-cycle counter such that the reference position indicated by the half-cycle counter matches the reference position indicated by the synchronization signal.

4. The physical address detector according to claim 1,
wherein the first and the second data segments include a type-identification flag indicating the type of the first data segment and the second data segment and an error detection code in addition to the physical address, and
when the synchronization signal has already been detected, if an error is not detected by the error detection code and the type indicated by the type-identification flag does not math the type determined by the type-determination counter, the address extraction section corrects the type determined by the type-determination counter to the type indicated by the type-identification flag.

5. The physical address detector according to claim 1,
wherein the counter section further includes a physical address counter for counting up a signal corresponding to the second cycle and generating a physical address, and
when the synchronization signal has already been detected, if the extracted physical address does not match the physical address generated by the physical address counter, the address extraction section corrects the physical address counter such that the physical address generated by the physical address counter matches the extracted physical address.

6. The physical address detector according to claim 1,
wherein the physical address includes a plurality of data units having the first cycle,
the physical address detector further comprises a unit-synchronization-signal detecting section for individually detecting a unit-synchronization-signal string disposed at the beginning of each of the data unit included in the first data segment and a unit-synchronization-signal string disposed at the position having a delay of a half of the first cycle from the beginning of each of the data unit included in the second data segment, and generating a unit synchronization signal.

7. An optical disc apparatus comprising:
a drive section for rotationally driving an optical disc;
a pickup for reading data from or writing data onto the optical disc; and
a physical address detector for extracting a physical address recorded as a wobble waveform on the optical disc from an output of the pickup,
wherein the physical address detector includes
an extraction section for extracting a first and a second data segments each including first cycles each having a predetermined cycle and second cycles each having a predetermined number of the first cycles from a wobble waveform recorded on an optical disc,
a synchronization-signal detecting section for individually detecting a synchronization signal string disposed at the beginning of the first data segment and a synchronization signal string disposed at the position having a delay of a half of the first cycle from the beginning of the second data segment, and generating a synchronization signal,
a counter section for counting up using one cycle of the wobble waveform as a basic unit on the basis of the synchronization signal in order to identify a position of a physical address included in the first and the second data segments, and
an address extraction section for extracting the physical address data from the first and the second data segments on the basis of the position of the physical address data identified by the counter section,
wherein the counter section includes
a half-cycle counter using a half cycle of the first cycle as a repetition cycle, and
a type-determination counter for inputting an output of the half-cycle counter, generating the first cycle, and determining either the first segment type or the second segment type is input.

8. The optical disc apparatus according to claim 7, further comprising a detection-window generation section for generating a detection window having a predetermined detection width with a position at which the synchronization signal is to be detected as center on the basis of an output of the half-cycle counter,
wherein the synchronization-signal detecting section detects the synchronization signal when there is the synchronization signal in a range of the detection window.

9. A method of detecting a physical address, comprising the steps of:
extracting a first and a second data segments each including first cycles each having a predetermined cycle and second cycles each having a predetermined number of the first cycles from a wobble waveform recorded on an optical disc;
synchronization-signal detecting for individually detecting a synchronization signal string disposed at the beginning of the first data segment and a synchronization signal string disposed at the position having a delay of a half of the first cycle from the beginning of the second data segment, and generating a synchronization signal;
counting by a counter section for counting up using one cycle of the wobble waveform as a basic unit on the basis of the synchronization signal in order to identify a position of a physical address data included in the first and the second data segments; and
address extracting for extracting the physical address data from the first and the second data segments on the basis of the position of the physical address data identified by the counting step,
wherein the counting step includes
half-cycle counting using a half cycle of the first cycle as a repetition cycle, and
type-determination counting for inputting a signal for each of the half-cycle obtained by the half-cycle counting step, generating the first cycle, and determining either the first segment type or the second segment type is input.

10. The method of detecting a physical address according to claim 9, further comprising the step of detection-window generating for generating a detection window having a predetermined detection width with a position at which the synchronization signal is to be detected as center on the basis of a count value obtained in the half-cycle counting step,
wherein the synchronization-signal detecting step detects the synchronization signal when there is the synchronization signal in a range of the detection window.
